(19) United States
(12) Patent Application Publication
(10) Pub. No.: US 2014/0155153 A1
(43) Pub. Date: Jun. 5, 2014

(54) App Promotion System Using Data-driven dynamically Generated Mini-Games

(71) Applicants: Ding Ye, (US); Zhan Ye, (US)

(72) Inventors: Ding Ye, Naperville, IL (US); Zhan Ye, Naperville, IL (US)

(73) Assignees: Zhan Ye, Naperville, IL (US); Ding Ye, Naperville, IL (US)

(21) Appl. No.: 13/693,405

(22) Filed: Dec. 4, 2012

(51) Int. Cl. A63F 13/12

(52) U.S. Cl. CPC A63F 13/12
USPC 463/31; 463/42

(57) ABSTRACT

Disclosed is an innovative app promotion platform that resides in a host app and utilizes third party apps' data (e.g. its app icon, graphics, video, and music) to dynamically create short-session mini games (e.g. quiz or picture puzzle) that can be played by the users. After playing the mini game, users will receive rewards that can benefit them in the host app. This new advertising approach is non-intrusive, provides deeper engagement from the users, thus creates better result for the advertisers.

The platform comprises of two components—a mechanism to dynamically generate mini games (Short session based, data-driven) and an achievement window, which contains info to promote the third party app and gives users in-app rewards.

The platform may be expanded in a global scale through offers of software development kits that allow other game developers and advertising networks to integrate the platform into their own games and networks.

### FIELD OF THE PRESENT INVENTION

The present invention is related to the technical field of mobile gaming, and in particular to providing mini games as an innovative method for app promotion and marketing.

### BACKGROUND OF THE INVENTION

Currently, an app is a software application that runs on smart phones, tablet computer's, and other mobile and computer, devices. With the success of iPhone, iPad, and Android phones, more and more apps are being introduced and how to promote and market them to end users becomes a difficult task.

App promotion networks partially address the need. App promotion networks are mobile ad networks or ad buying platforms that place ads across other mobile apps. Many existing app promotion networks utilize banners and video ads. These ads are non-interactive and not very engaging, thus limiting their capability to deliver good results to the advertisers.

The inventor designed a new system that uses data-driven, dynamically generated mini games to promote apps. And also believe the system can significantly improve the performance due to its non-intrusive, highly engaging and entertaining nature.

### SUMMARY OF THE INVENTION

Accordingly, the object of the present invention is provide an innovative app promotion platform that resides in a host app and utilizes third party apps' data (e.g. its app icon, graphics, video, and music) to dynamically create short-session mini games (e.g. quiz or picture puzzle) that can be played by the users. After playing the mini game, users will receive rewards that can benefit them in the host app. This new advertising approach is non-intrusive, provides deeper engagement from the users, thus creates better result for the advertisers.

The platform comprises of two components—a mechanism to dynamically generate mini games (Short session based, data-driven) and an achievement window which contains info to promote the third party app and give users in-app rewards.

### BRIEF DESCRIPTION OF THE DRAWINGS

FIG. 1 is a flow diagram of an app promotion system using data-driven dynamically generated mini-games according to a preferred embodiment of the present invention.

FIG. 2 is a sample of the mini game screen.

FIG. 3 is a sample of the achievement window/result screen.

FIG. 4 is a flow chart showing the logic behind the achievement window/result Screen.

### DETAILED DESCRIPTION OF THE PREFERRED EMBODIMENTS

### Definitions

App: Application software. For example, games on App Store.

System: An innovative app promotion platform introduced here.

Cross-promotion: While the user is running an app (The host app), another app is being promoted via banner or video ads displayed on the host app. Example, ad banner network such as Admob.

Host app: An application software integrated with the System. The user interacts with the host app and when certain conditions are met, the System will be triggered and lead the user to its workflow.

Third-party app: An application software that the system tries to cross promote from the host app using highly engaging interactive mini-games.

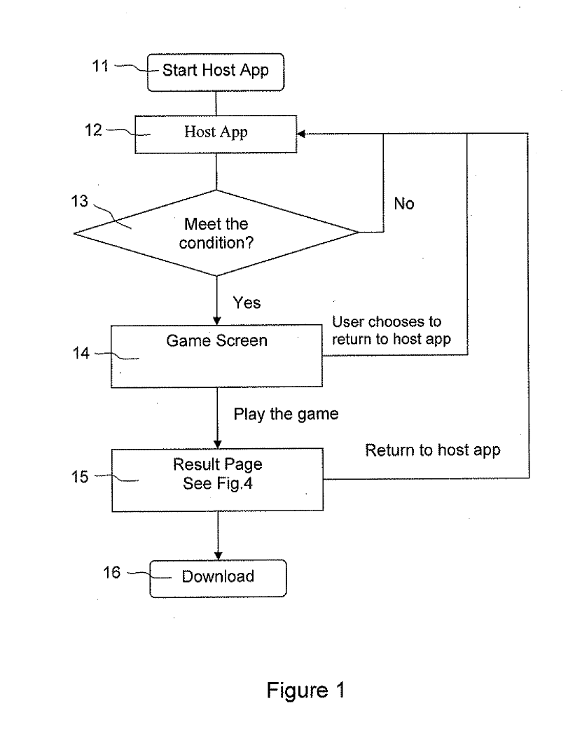

FIG. 1. is a flow diagram of an example of a system implementing the app promotion techniques introduced here.

The system launches a mini game in a Game screen (14) from the host app (12) when certain conditions (13) are met. Certain conditions can include finishing certain tasks in the host app, entering or exiting from certain screens of the host app. Certain conditions can further include play time or player score reaching certain threshold if the host app is a game app.

The mini game on the Game Screen is dynamically generated by the system using one of a set of pre-defined gameplay styles and data of a third party app, which can be its logo icon, graphics, video and sound, retrieved automatically or manually (With verification and edit) from digital application distribution platforms such as Apple's App Store and Google's Google Play. The system combines the chosen gameplay style with third party app data and presents the interactive mini game to the user.

Each mini game is based on a specific third party app. The system determines which app to use out of all the available apps on the digital application distribution network, either randomly or based on certain criteria (e.g. sponsors of a specific app promotion campaign may be given priority to show up more over other apps).

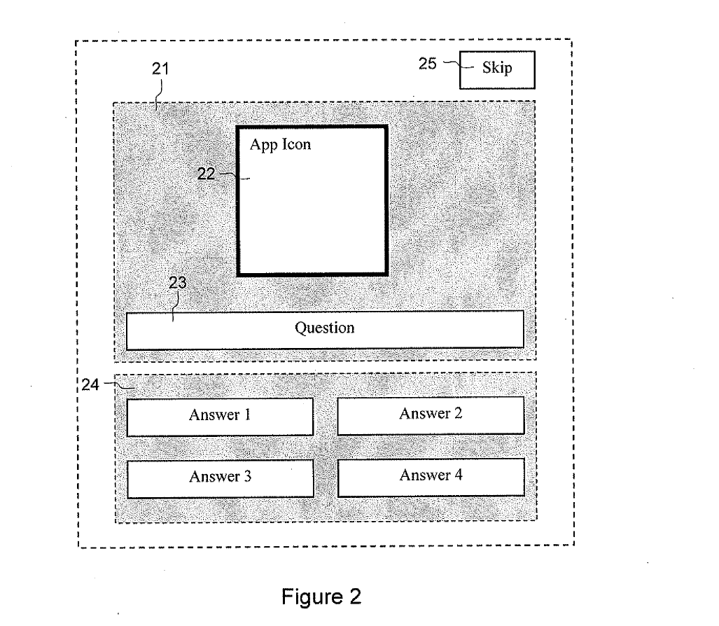

FIG. 2 is an example of the Game Screen. It shows an interactive mini game (21) that can be played by the user. Depending on the type of the mini-game and gameplay style, there can be many different screen layouts. The sample screenshot shows a quiz game, in which the user needs to guess the app's category from the visual image of its app icon. An app icon is displayed at the top (22); followed by a question (23) (e.g. What app category does this app belong to?); followed by four answers that the user can select from (24) (e.g. Family, Shooting, Racing, Puzzle).

As shown in FIG. 2, the Skip button (25) allows the user to quit and go back to the host app (12).

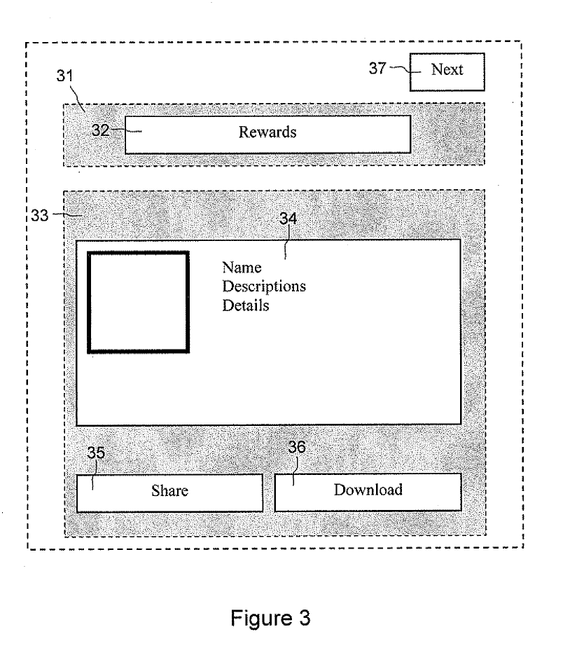

As shown in FIG. 3 is an example of the Result Screen, containing the following three components: achievements and rewards (31); detailed info about the third party app, which may include app name, developer name, description, reviews, and screenshots (34); options to download and share (33); a Next button (37) to take the user back to the host app (12).

The user plays the mini game on the Game Screen. When the user is done playing, an Achievement Window/Result Screen (15) will be displayed.

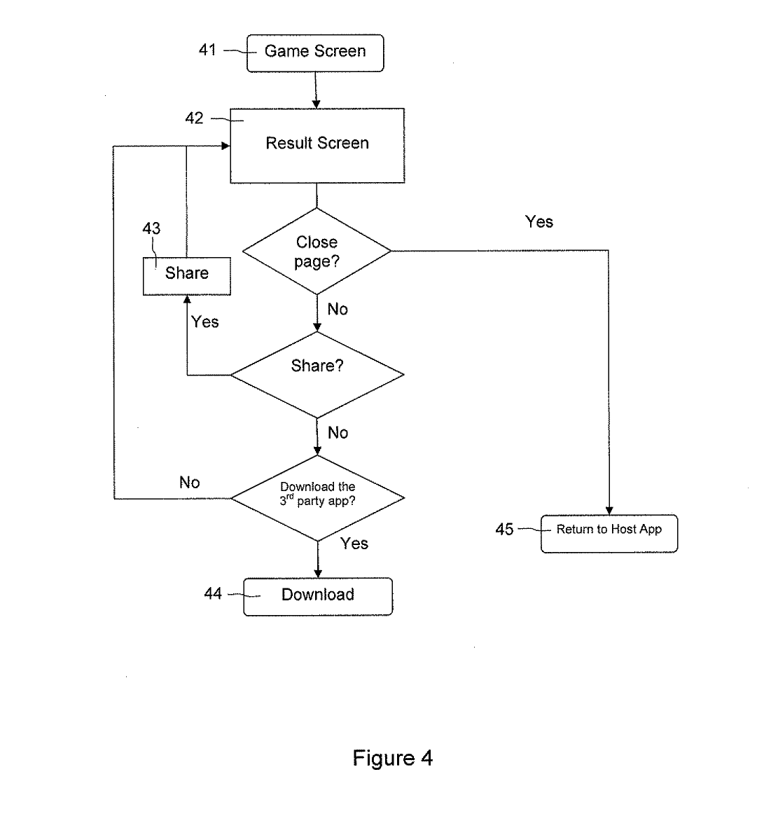

FIG. 4 is a flow diagram of the Result Screen workflow.

The user receives certain in-app rewards for playing the mini game. In-app rewards are benefits that the user can enjoy in the host app. They can be in the forms of in-app currency, virtual items, and unlocked contents. For example, the system may reward the user with 200 coins for successfully answering a quiz or 50 coins for partially answering the question.

The user can choose to share the achievements with friends via email, text message, or social networks such as Facebook and Twitter (35, 43).

The user can choose to download the app directly or through a digital application distribution platform (36, 44).

Although the present invention has been described with reference to specific exemplary embodiments, it will be recognized that the invention is not limited to the embodiments described, but can be practiced with modification and alteration within the spirit and scope of the appended claims. Accordingly, the specification and drawings are to be regarded in an illustrative sense rather than a restrictive sense,

What is claimed is:

1. A method for providing in-app promotions, the method comprising: providing a mini-game to the user in the host app; giving the user in-app rewards for playing the mini-game and displaying promotional info about a third party app; and providing the ability to share the gameplay experience and achievements with friends using social networks.

2. The method of claim 1 further comprising, launching the system when certain conditions are met when the host app is run by the user.

3. The method of claiml further comprising, dynamically generating the mini-game based on third party app data.

4. The method of claim 3 further comprising, displaying third party app data and other related info (e.g. app icon, text, graphics, video, and music) and making them an integral part of the mini game's interaction and gameplay.

5. The method of claim 3 further comprising, displaying an achievement window after the user played the mini game.

6. The method of claim 5, wherein displaying an achievement window includes displaying and giving the user in-app rewards, displaying more detailed info about the third party app, and providing a sharing function.

7. The method of claim 6, wherein displaying and giving the user in-app rewards includes displaying and giving in-app currency, virtual items, and unlocked contents.

8. The method of claim 6, wherein more detailed info about the third party app includes the name of the third party app, icon, screensho s, description, company name, and link to download.

9. The method of claim 8, wherein link to download includes either a link to a web site or an app store so that the user can download the app directly or indirectly.

10. The method of claim 6, wherein providing a sharing function includes publishing certain promotional and viral info about the user's achievements onto social networks such as Facebook and Twitter.
